(19) United States
(12) Patent Application Publication
(10) Pub. No.: US 2016/0353239 A1
(43) Pub. Date: Dec. 1, 2016

(54) APPARATUS AND SYSTEM FOR AN ELECTRONIC LOCK, AND METHODS OF USE AND MANUFACTURE THEREOF

(71) Applicant: Friday Labs Limited, London (GB)

(72) Inventors: Johan Marcus Robert Kjellsson, Osterbro (DK); Guan Yang, New York City, NY (US)

(21) Appl. No.: 15/169,662

(22) Filed: May 31, 2016

Related U.S. Application Data
(60) Provisional application No. 62/167,271, filed on May 28, 2015.

(51) Int. Cl. H04W 4/02; G07C 9/00

(52) U.S. Cl. CPC H04W 4/021; G07C 9/00309; G07C 2009/00412; G07C 2209/64

(57) ABSTRACT

An electronic lock for controlling a lock mechanism includes a processor, a controller coupled to the processor and configured to change a locked/unlocked status of the electronic lock, a first communication receiver configured to receive information indicating a user proximity event relative to the electronic lock, and a transceiver coupled to the processor, the transceiver configured to receive data from a remote application over a network. The processor can be configured to define a geofencing boundary around the electronic lock, transmit the geofencing boundary information to the remote application over the network, receive data from the remote application over the network indicating a geofencing entry or exit event, and transmit an unlock command to the controller if a user's location is within a predetermined distance of the electronic lock and a user geofencing entry event occurred within a first predetermined prior time frame.

### CROSS-REFERENCES TO RELATED APPLICATIONS

This application claims the benefit 35 U.S.C. Sec. 119(3) of of U.S. Provisional Patent 62/167,271 entitled, “APPARATUS AND SYSTEM FOR AN ELECTRONIC LOCK, AND METHODS OF USE AND MANUFACTURE THEREOF,” filed May 28, 2015.

### BACKGROUND

Electronic locks typically authenticate a user based on a physical device that the user interacts with. For example, the user may: enter a numeric code into a keypad, authenticate by biometric means such as fingerprints, retinal scans, or voice recognition; swipe a magnetic card, use a radio frequency identification (RFID) card, approach the lock with a key fob. Modern electronic locks, especially for the consumer market, can authenticate the user through a smartphone or similar device. Smartphones can communicate with home automation devices through the Bluetooth® Low Energy standard, which was introduced in Bluetooth® 4.0. Other electronic locks can communicate using other standardized radio frequency communication protocols such as the Zigbee and the Z-Wave wireless protocols.

Some electronic locks for doors on structures can be locked or unlocked automatically depending on the actuation command provided by electronic access control algorithms and mechanisms. The locks may be actuated remotely over a network accessible system and web service that can communicate with a server. The server could be accessed from portable electronic devices with Internet connections that can communicate with remotely operable locks such as radio frequency controlled deadbolt locks, doorknob locks, or electrical strikes that can be actuated remotely by communicating with a server through encrypted Internet communication protocols.

### SUMMARY

The disclosed subject matter relates to the field of automated locking technologies. In particular, some embodiments relate to methods and systems for controlling, or assisting the control of, an electronic lock. To make newer smart locks easier to use than traditional electronic or mechanical locks, there is a desire for automatic locking and unlocking. Ideally, the user will never have to physically retrieve a phone or other token to operate the lock. After an initial pairing, an application may register with the mobile operating system to be notified when the mobile device is in the vicinity of the lock. A prior lock implementation might unlock as soon as this notification is received. However, there are some problems with such an approach. If the user is already inside the house, for example if the user walked downstairs and now stands near the front door, the user may not intend to unlock the door. In fact, the user may have walked up to the door to look out the peephole and determined if an intruder is outside. In this situation, it would be potentially dangerous to automatically unlock the door.

It may be beneficial, in the context of an electronic lock, a security access system, and methods for a locking mechanism, to accurately determine the user's intent, that is, whether the user intends for the electronic lock to automatically lock under certain circumstances and scenarios. It may also be beneficial for an electronic lock system to determine the user's intent, i.e., whether the user intends for the lock to automatically unlock.

There are various realized and hypothesized methods of determining whether the user is inside or outside the door. For example, a system could use multiple antennas or directional antennas, and RSSI or time-of-arrival based methods to determine whether the user is inside or outside of the door. Unfortunately, these are difficult to realize using low-cost, off-the-shelf Wi-Fi and Bluetooth® LE radios. Highly directional antennas at 2.4 GHz (the frequency of both Wi-Fi and Bluetooth® LE) are also of impractical size.

It may therefore be beneficial to provide an apparatus, system, and method for a security access system and an electronic lock that can mechanically operate a lock or unlock action, that can determine a user's location, and that anticipate a user's intent to automatically lock or unlock an electronic lock.

The embodiments can include an electronic lock for controlling a lock mechanism. In one aspect, the electronic lock can include a processor, a controller coupled to the processor and configured to change a locked/unlocked status of the electronic lock, a first communication receiver configured to receive information indicating a user proximity event relative to the electronic lock, and a transceiver coupled to the processor, the transceiver configured to receive data from a remote application over a network. The processor can be configured to define a geofencing boundary around the electronic lock, transmit the geofencing boundary information to the remote application over the network, receive data from the remote application over the network indicating a geofencing entry or exit event, and transmit an unlock command to the controller if a user's location is within a predetermined distance of the electronic lock and a user geofencing entry event occurred within a first predetermined prior time frame.

In another aspect, a computer-implemented method for controlling an electronic lock can include, under one or more computer systems configured with executable instructions, defining a geofencing boundary around the electronic lock, receiving data from an application indicating a user geofencing entry event, receiving configuration data including a locked/unlocked status of an electronic lock, receiving information from the electronic lock indicating a user proximity event relative to the electronic lock, transmitting, by the one or more computer systems, an unlock command to electronic lock if a) the information indicating the proximity event indicates the user's location within a predetermined distance of the electronic lock, and b) the geofencing entry event occurred within a first predetermined prior time frame

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a schematic of an illustrative architecture for facilitating processes of an access control system and lock in accordance with the disclosed subject matter.

FIG. 2A is a schematic of an exemplary architecture for a lock in accordance with the disclosed subject matter.

FIG. 2B is a schematic of an exemplary architecture for a personal access device in accordance with the disclosed subject matter.

FIG. 2C is a schematic of an exemplary architecture for a security network system in accordance with the disclosed subject matter.

FIG. 3A is perspective view of a lock configured in accordance with the disclosed subject matter.

FIG. 3B is plan view of the lock of FIG. 3A configured in accordance with the disclosed subject matter.

FIG. 4. is a flowchart of an exemplary process for calibration and setup of the lock in accordance with the disclosed subject matter.

FIG. 5 is a schematic of an illustrative architecture for facilitating operations of the embodiments in accordance with the disclosed subject matter.

FIG. 6 is a flowchart of an exemplary process for detecting a geolocation of the personal access device of the embodiments in accordance with the disclosed subject matter.

FIG. 7 is a flowchart of an exemplary process for a geofencing locking event to activate the lock of the embodiments in accordance with the disclosed subject matter.

FIG. 8 is plan view of the lock configured with a motion detection device in accordance with the disclosed subject matter.

FIG. 9 is a flowchart of an exemplary process for operation of the lock of the embodiments in accordance with the disclosed subject matter.

FIG. 10 is a plan view of the lock configured with an accelerometer in accordance with the disclosed subject matter.

FIG. 11 is a flowchart of an exemplary process for automatically calibrating the lock of the embodiments in accordance with the disclosed subject matter.

FIG. 12 is a flowchart of an exemplary process for operating the lock of the embodiments in accordance with the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Like numbers refer to like elements or steps throughout, and prime notation is used to indicate similar elements or steps in alternative embodiments. The flow chart blocks in the figures and the description depict logical steps and/or reason code from a reason code module to operate a processor, computer system, controller, compounding system, etc. to perform logical operations and control hardware components and devices of the embodiments using any appropriate software or hardware programming language. In one embodiment, object code in a processor can generate reason codes during execution of the associated logical blocks or steps.

Some of the disclosed embodiments relate to automatic locking mechanisms and systems and methods of operation thereof. In the embodiments, locking mechanisms with automated locking technology can include or other cover locking systems, devices, and mechanisms for use in facilities including homes, apartments, condominiums, office buildings, warehouse and industrial buildings, shipping containers, storage facilities and containers, travel and protective cases, vehicles including automobiles, trucks, motorcycles, personal devices such as a computer or mobile device, or any system, device, or structure capable of being locked or transmitting a lock or unlock command. In fact, the various disclosed methods, devices, and systems are intended to be usable with any type of automated, semi-automated, or user-assisted system, device, or process for locking a structure, building, object, transport-related entity, etc. Some of the disclosed embodiments relate to methods and systems for automatic locking mechanisms and mechanical security locks such as, but not limited to, deadbolt locks, warded locks, pin tumbler locks, wafer tumbler locks, disc tumbler locks, lever tumbler locks, and electronic locks such as, but not limited to, locking systems using access control systems, keycard locks, smart locks, biometric locks, magnetic locks, keypad locks, and other keyless entry systems.

Some of the disclosed embodiments relate to access control systems, access control networks, and computer-implemented methods associated therewith. Examples of access control systems that could implement the embodiments include systems configured with one or more computer processors, computer memory, controllers, and computer networks and databases. The access control systems of the embodiments can interface with various networks including Wi-Fi networks or other wireless networks, the Internet or other broadband network, cellular networks, network servers, detection sensors, mobile devices, computing devices, and other access control (e.g., security) systems.

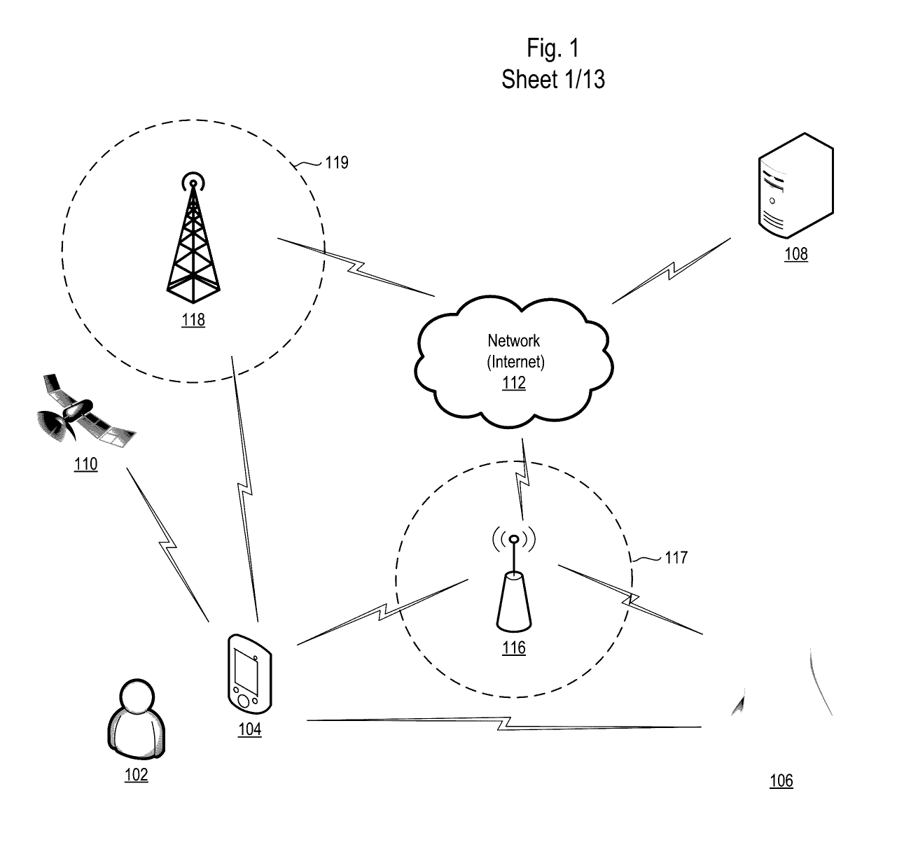

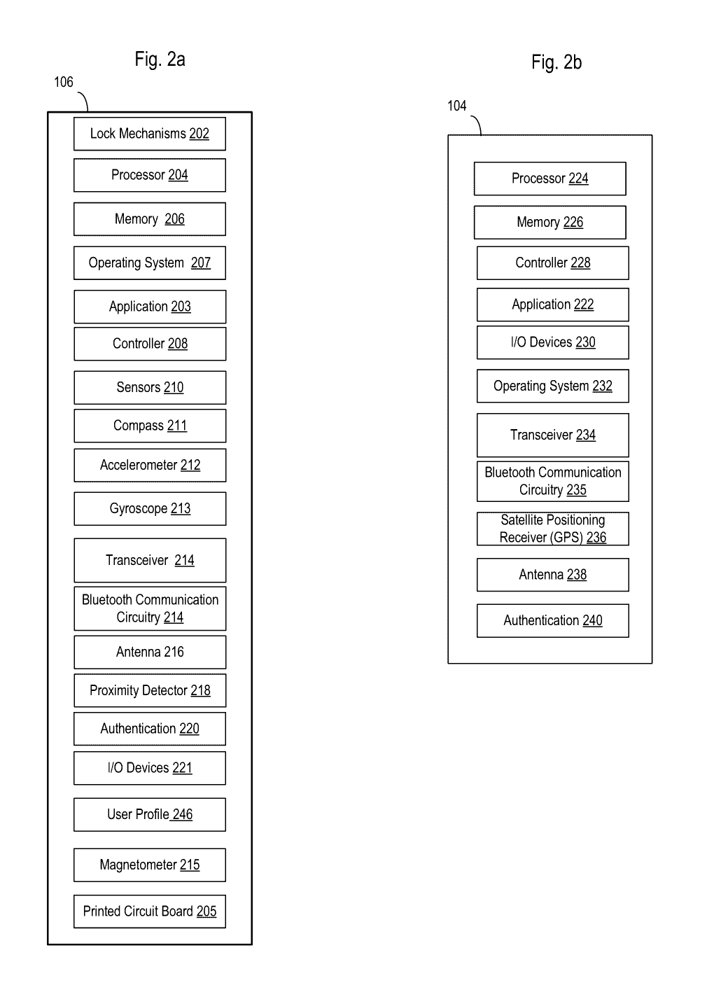

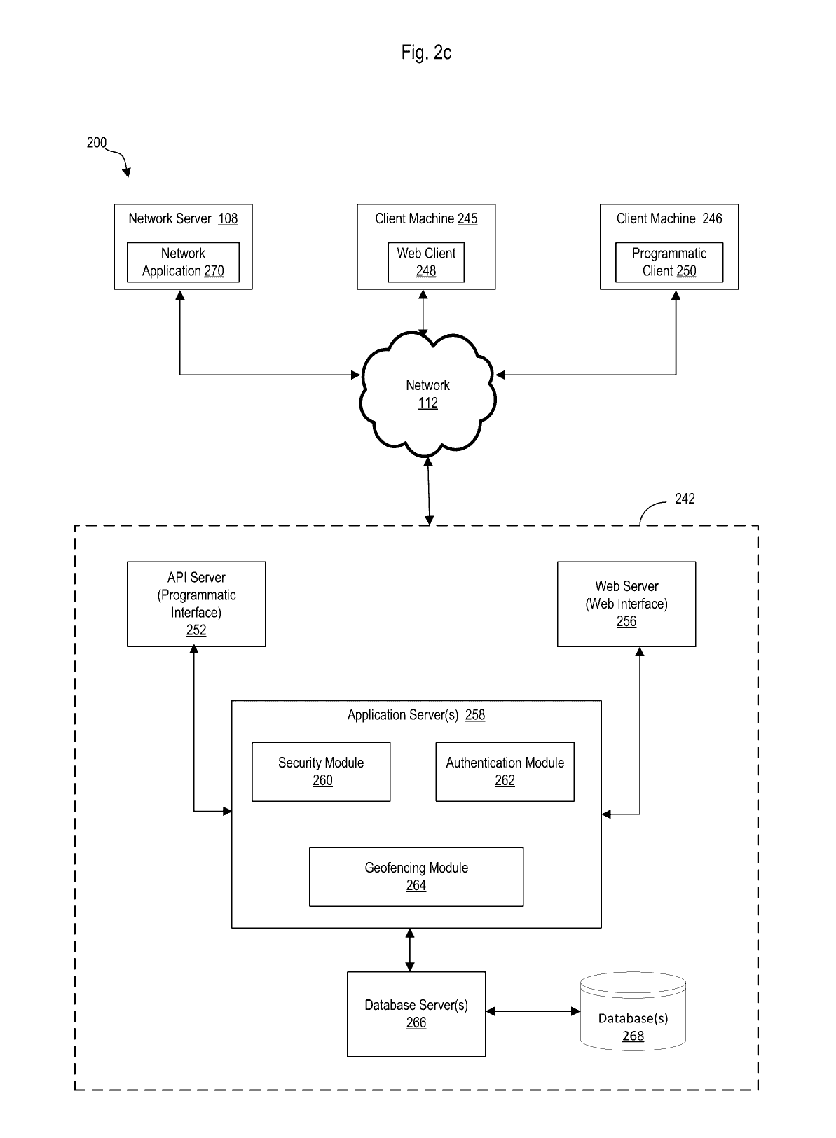

FIG. 1 is a schematic of an illustrative architecture 100 for facilitating processes of an access control system and lock of the embodiments. A representative user 102 employs a personal access device 104 (e.g., mobile device, mobile telephone/smartphone, computer tablet, personal computer, wrist-worn devices, etc.) to interact over one or more networks (e.g., cellular network 119 via cell tower 118, broadband network such as Internet 112, wireless network 117 via access point 116) with one or more exemplary locks 106 and a security access system 200 (see FIG. 2) on a network server 108 or the lock 106. In the embodiments, the wireless network 117 can include, or otherwise cover, a Wi-Fi network, a network using Z-Wave radio protocol, a network using 802.15.4 based protocols such as ZigBee and Thread, or any 802.x network protocol, currently known or future-developed. The personal access device 104 may receive signals from a global positioning satellite 110 (e.g., GPS, GLONASS, etc.) that can indicate a location of the personal access device 104, and in turn the user 102 operating the device 104.

The lock 106 may be installed in a standard deadbolt hole or other locking location, and may be battery powered, for example. The lock 106 may be a manually controlled lock, for example by user 102 rotating the lock by hand, or include an internal mechanism 202 to rotate the lock 106 by an internal motor (e.g., DC brushed, servo, stepper, brushless DC motor, etc.), thereby moving a locking apparatus, such as a deadbolt, to a locked position, unlocked position, or a position between a locked and unlocked position.

FIG. 2A is a schematic of an exemplary architecture for the lock 106 of the embodiments. The lock 106 can include, but is not limited to, one or more lock mechanisms 202, a processor 204, a memory 206, a controller 208, one or more sensors 210, an accelerometer 212, a gyroscope 213, a compass 211, a transceiver 214 for communicating with a network, an antenna 216, a proximity detector 218, communication circuitry 214, a proximity detector 218, input/output devices 221, and an authentication application 220. The processor 204 may be any of a variety of different types of commercially-available processors suitable for security devices or mobile devices (for example, XScale architecture microprocessor, a Microprocessor without Interlocked Pipeline Stages (MIPS) architecture processor, or other processor). The memory 206 can include, but is not limited to, a Random Access Memory (RAM), a Flash memory, a hard drive memory, or other type of memory that is typically accessible by the processor 204. The memory 206 can be adapted to store an operating system (OS) 227, as well as one or more application programs 203, such as, but not limited to, a smart lock-enabled application (SLA) that can provide smart lock configuration, calibration, and/or customization to the user 102. A controller 208 can be a separate module adapted to be accessed by the processor 204 and/or memory 206 or alternatively could be included as an application 203 within the memory 206. The processor 204 and/or the controller 208 can execute applications 203 stored in the memory 206, for example applications 203 that can control the lock mechanisms 202 including hardware/software to operate the lock 106. Rather than a single processor 204 to perform all the steps described herein, some of the components may each have their own processor that only performs calculations related to the component's specific function.

The processor 204 may be coupled, either directly or via an appropriate intermediary hardware, to the input and output devices 221 including but not limited to a display, a keypad, a touch panel sensor, a microphone, etc. In some embodiments, the processor 202 can similarly be coupled, either directly or via an appropriate intermediary hardware, to one or more of the hardware or electronic components of the lock 106 such as the gyroscope 213, the compass 211, the accelerometer 212, etc. that can be mounted independently or on a printed circuit board (PCB) that is coupled or operationally connected to the lock 106. Similarly, the processor 204 may also be coupled to the transceiver 214. The transceiver 214 may be configured to both transmit and receive cellular network signals, wireless network signals, or other types of signals via the antenna 216, depending on the nature of the circuitry and applications 203 within the lock 106. In this manner, the transceiver 214 can provide wireless communication to the wireless network 117 and/or another network that can enable an external computing device, such as remote access device 104, to interact with and/or operate the lock 106.

In an alternative embodiment, to avoid excess power consumption of communicating directly with the cellular network 119, the transceiver 214 can provide wireless communication via a short-range, low power wireless connection (e.g., Bluetooth® or equivalent connection) using circuitry 214, or Wi-Fi connection to the wireless access point 116 of wireless network 117. The short-range wireless communication can include or otherwise cover wireless communications using Z-wave communications, an 802.x protocol communication such as Zigbee, Thread, or 6LoWPAn, or other proprietary wireless network protocols, etc. In other embodiments, wireless access point 116 can include communication using 802.15.4 protocols, which can optionally provide mesh networks such that messages between the lock 106 and the access point 116 that may be relayed through several other devices in a home or structure.

The processor 204 may be coupled to the proximity detector 218 for detecting the presence of the user 102. The proximity detector 218 can include, but is not limited to, a touch sensor, a mechanical or digital button, a radio frequency signal strength detector, an audio detector, a photo-sensitive detector, a laser scanner, a motion sensor/detector, etc. The proximity detector 218 can output detection signals to the controller 208.

The processor 204 may be further coupled to the gyroscope 213, which can measure a relative angle of the turn of the lock and indicates how much a handle of lock 106 has moved (e.g., rotated in a first direction or a second direction). The processor 204 may also be coupled to the compass 211, which can measure an angle of a door configured with the lock 106 in order to indicate whether or not the door is in a correct position to be locked (e.g., a closed position) or in an incorrect position to be locked (e.g., an open position).

The authentication application 220 can include an application to generate encrypted keys for providing secure access to the lock 106 by the user 102. Locked commands and other messages to and from the lock 106 can be authenticated using an encryption technique, such as the public-key-authenticated symmetric encryption or other encryption technology. During an initial setup, the lock authentication 220 can generate its own public/secret key pair which can be used to send authenticated messages to the lock 106. The lock 106 can also be programmed with the public key of an application stored within an application (corresponding to a secret key stored within a secured area such as authentication section 220), as well as one or more public keys stored in a user profile 246 on the network server 108. Subsequently, either the network server 108 or an authentication section of the application 222 may issue unlock or other commands, or request information, by sending authenticated and encrypted messages to the lock 106.

FIG. 2B is a schematic of an exemplary architecture for the personal access device 104 of the embodiments. In various embodiments, the personal access device 104 can include, but is not limited to, a mobile wireless communications device (e.g., smartphone, smartwatch, tablet, hearable device, key FOB, etc.). The personal access device 104 architecture can include but is not limited to a memory 226, a processor 224, an operating system 232, a controller 228, one or more input/output devices 230, a transceiver 234, short-range communication circuitry 235, a satellite positioning receiver (e.g., GPS receiver) 236, an antenna 238, and an authentication section 240. Rather than a single processor 224 to perform all the steps described herein, some of the components may each have their own processor that only performs calculations and transactions that related to the component's specific function.

The processor 224 may be any of a variety of different types of commercially-available processors suitable for mobile devices (for example, XScale architecture microprocessor, a Microprocessor without Interlocked Pipeline Stages (MIPS) architecture processor, or other processor. The memory 226 can include, but is not limited to, a Random Access Memory (RAM), a Flash memory, or other type of memory that is typically accessible by the processor 224. The memory 226 can be adapted to store the operating system (OS) 232, as well as one or more application programs 222, such as but not limited to a smart lock application, security application, geofencing application, etc. A controller 228 can include a separate module adapted to be coupled to the processor 224 and/or memory 226 or alternatively could be included as one of the applications 222 within the memory 226 with instructions executed by the processor 224. The processor 224 and/or controller 228 can execute and/or control applications 222 stored in the memory 226, for example applications 222 that can control lock mechanisms 202 and hardware/software to operate the lock 106.

The processor 224 may be coupled, either directly or via an appropriate intermediary hardware, to various input and output devices 230 including but not limited to a display, a keypad, a touch panel sensor, a microphone, etc. The processor 204 may be coupled to the transceiver 234. The transceiver 234 may be configured to both transmit and receive cellular network signals, wireless network signals, or other types of signals via the antenna 238, depending on the nature of the circuitry and applications 222 within the personal access device 104. In this manner, the transceiver 234 can provide wireless communication to the wireless network 117 and/or another network.

The personal access device 104 can include an encrypted key or token stored in authentication section 240 or the application 222 in memory 226 that is authorized to control the lock 106. In an embodiment, the personal access device 104 can also be programmed with the public key of an application stored within an application (corresponding to a secret key stored within lock authentication section 240). Subsequently, an application on the personal access device 104 may issue unlock or other commands, or request information, by sending authenticated and encrypted messages to the lock 106.

Additionally, or in an alternative embodiment, the personal access device 104 can include a standard key or token including the controller 228 that is authorized to control the lock 106 via wireless signals transmitted by the transceiver 234. Certain transceivers can include, but is not limited to, a Bluetooth® low energy signal that can be received by the transceiver 234.

The transceiver 234 can cooperate with the application 222 stored in memory 226 that can be configured to have the processor 224 command the transceiver 234 to send a signal over one or more networks including the cellular network 119, Internet 112, wireless network 117, etc. to provide interaction with and/or control over lock 106.

FIG. 2C is a schematic of an exemplary architecture for a security network system according to the embodiments. The schematic depicts the security access system 200 (in the exemplary form of a client-server system), within which an exemplary embodiment can be deployed. One or more components of the exemplary security access system 200 may reside on the network server 108, the lock 6, the personal access device 104, or any other device that is known or can be developed for communication within the exemplary architecture.

A network system 242 is illustrated, in the example form of a network-based location-aware security application that provides server-side functionality, via the network 112 to one or more client machines 245, 246, the personal access device 104, and the lock 106. A web client 248 (e.g., a browser, such as the Internet Explorer, Chrome, Firefox, etc.) and a programmatic client 250 (e.g., mobile version of the security application, authentication application, etc.) can operate on respective client machines 245 and 246. In an embodiment, the client machines 245 and 246 can be but are not limited to, machines configured as a mobile device, such as the personal access device 104, or as the lock 106.

An Application Programming Interface (API) server 252 and a web server 256 can be coupled to, and provide programmatic and web interfaces respectively for, one or more client machines 245, 246, network server 108, etc. The application server 252 can host one or more security modules 260 authentication modules 262, and geofencing modules 264. In certain examples, these can include security applications to interoperate with the lock 106, or can be an application to interoperate with a third-party security system), The application server 252 is, in turn, illustrated to be coupled to one or more database servers 266 that facilitate access to one or more databases 268. In some embodiments, the application server 252 can access the database 268 directly without the need for a database server 266.

In some embodiments, the security module 260 may allow the user 102 to access, configure, calibrate, and operate one or more locks 106 and may allow the user 102 to interoperate with a third-party security system. The authentication module 262 may allow users to interoperate with authentication applications 220 including encryption applications to provide a high level of security for users within the network-based security access system 200. Both the security module 260 and the authentication module 262 can be configured to facilitate operation of the lock 106 in conjunction with one or more geofencing module 264. The geofencing module 264 may provide generation and updating of user-defined geofences via a geofencing application. While the security module 260, authentication module 262, and geofencing module 264 are illustrated to all form part of the network system 242, it will be appreciated that, in alternative embodiments, one or more of the security module 260, authentication module 262, and geofencing module 264 may form part of one or more security system services that are separate and distinct from the network system 242.

Further, while the security access system 200 illustrated in FIG. 2C employed a client-server architecture, the exemplary embodiments are not limited to such an architecture, and could equally find application in a distributed, peer-to-peer, or cloud architecture systems, etc. The one or more security modules 260, authentication modules 262, and geofencing modules 264 could also be implemented as standalone systems or software programs, which do not necessarily have networking capabilities.

The web client 248 can access the security module 260, authentication module 262, and geofencing module 264 via the web interface supported by the web server 256. Similarly, the programmatic client 250 can access the service sand functions provided by the security module 260, authentication module 262, and geofencing module 264 via the programmatic interface provided by the API server 252.

FIG. 2C also illustrates a network application 270 that can execute on the network server 108, which can be a third-party server, and provide programmatic access to the network system 242 via the programmatic interface provided by the API server 252. for example, the network application 270 may, utilizing information retrieved from the network system 242, support one or more features or functions on a website hosted by a third party. The third party website may, for example, provide or more security applications that can access or interoperate with a third party security system.

The database 268 can include and one or more user data log sections configured as one or more databases and one or more user profile sections that may store user information in a database including but not limited to security credentials, a user's lock specifications, custom configurations of applications, calibrations and setup of a lock, and past, present, or future security events. The data log section may store data and other information in a database including time logs, security events, user locations and movements, or any data related to the lock 106, systems, methods, and devices interoperating with the lock 106, and a user's interaction with and operation of the lock 106.

The exemplary security access system 200 is intended to be implemented with any known, related art or later developed technologies. Additionally, the exemplary security access system 200 may be associated with other lock apparatuses and methods or used in other applications. Other embodiments of access systems associated with some automatic or semi-automatic locking mechanisms may include different elements and/or arrangements as configured for the security access system 200, but may be configured to operate similar to, and be compatible with, the security access system 200.

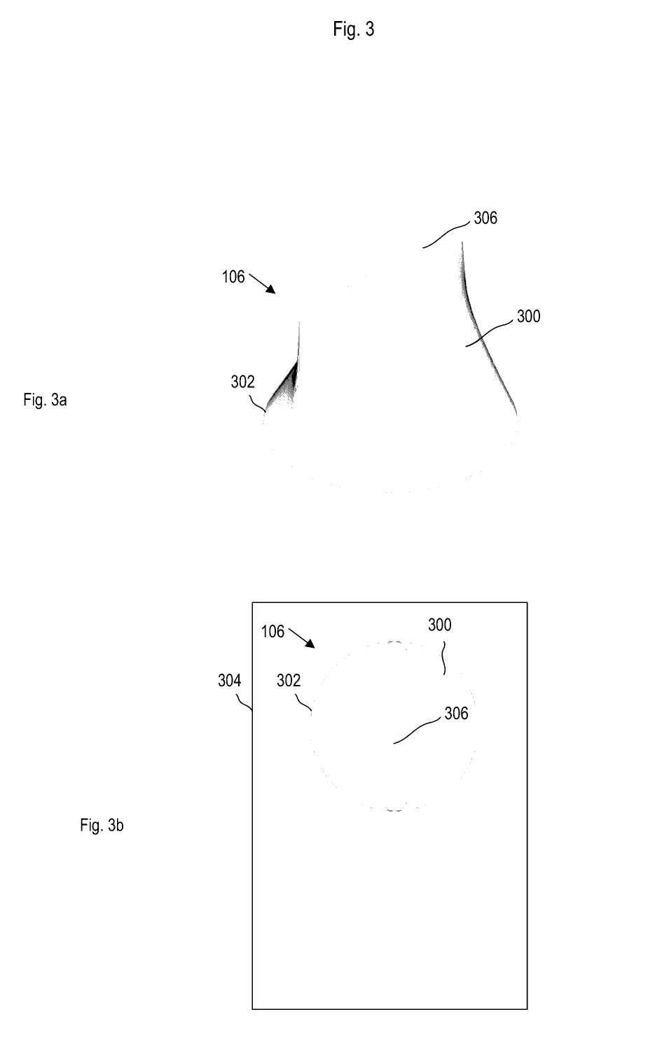

FIG. 3a is perspective view of the lock 106 configured in accordance with the embodiments, and FIG. 3b is plan view of the lock 106 configured in accordance with the embodiments. The lock 106 can include a handle 300 formed as an elongated frusto-conical surface that can begin at a circular base 302 that terminates at truncated top 306. The lock 106 may be mounted to a door 304 or other structure. In other embodiments, the lock 106 may be configured in other shapes such as, but not limited to, polygonal, cylindrical, conical, etc. and may include one or more apparatuses combined into an assembly to form the lock 106 or may include one or more apparatuses separated by physical distances to function as automatic lock 106. In other embodiments, the lock 106 can be configured as a doorknob lock, handle lock, or other style lock.

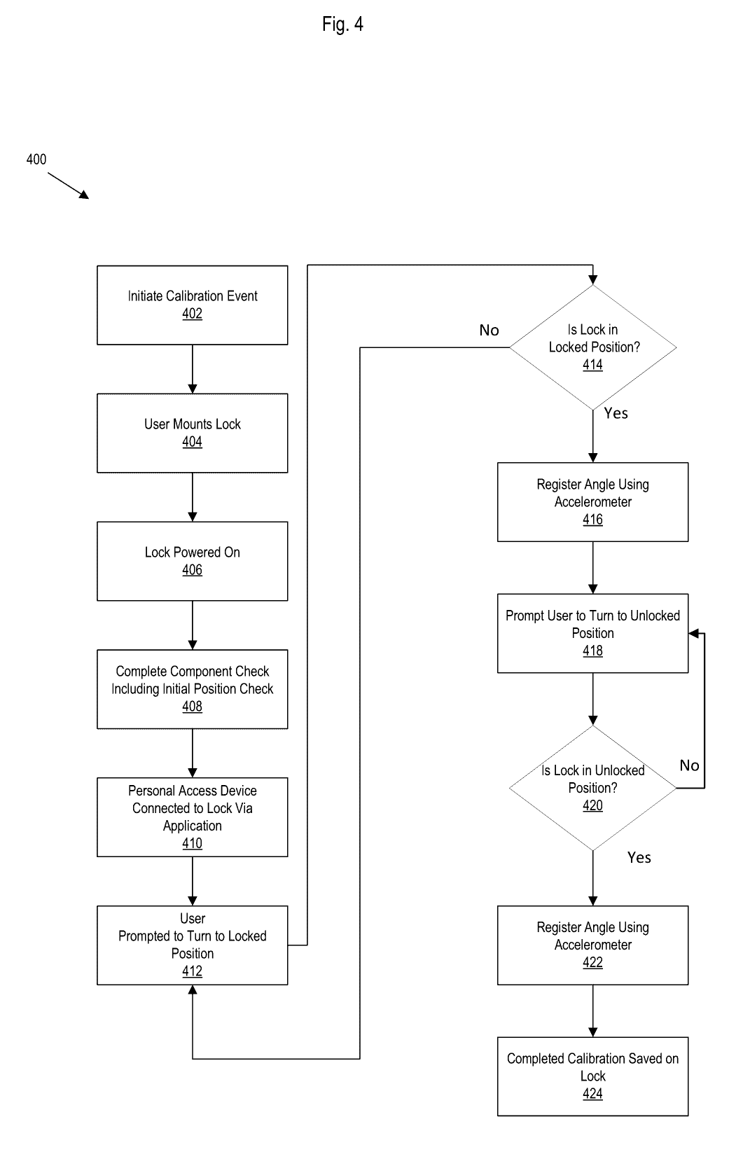

FIG. 4. is a flowchart of an exemplary process 400 and algorithm for calibration and setup of the lock 106. The process for calibration and setup of the lock 106 may include step 402 to initiate a calibration event. In block 404, a user can physically and/or operationally mount the lock 106 for locking operation or otherwise configure the lock 106 for testing. The process 400 may further include block 406, where the processor 204 can power the lock 106 on, and block 408, where the processor 204 can complete a component check including an initial position check. At block 410, the process may include the processor 204 connect the personal access device 104 wirelessly to the lock 106 via the transceiver 234. In block 412, the processor can prompt the user 102 via the application 222 to turn the lock 106 to a locked position. In block 414, the processor 204 can receive data from the sensors 210 as to the position of the lock 106, such as whether the lock 106 is in a locked position. If not, then the processor 204 can return the method to block 412 and prompt the user 102 again to turn the lock 106 to a locked position. If the sensors 210 indicate the lock 106 is in a locked position, the processor 204 proceeds to block 416 to measure and register the lock's angle of turn at the locked position using the accelerometer 212. Next, the process can include block 418 where the processor 204 can prompt the user 102 to turn the lock 106 to an unlocked position. In block 420, the processor 204 can receive data from sensors 210 as to whether the lock is in an unlocked position. If not, then the processor can return to block 418 and prompt the user 102 again to turn the lock 106 to an unlocked position. If the sensors 210 indicate the lock 106 is in an unlocked position, the processor 204 can proceed to block 422 to measure and register the angle of turn using the accelerometer 212. After the lock's position is registered in both a locked an unlocked position, then in block 424 the processor can determine that the process 400 is complete.

The embodiments can also include, but is not limited to, systems and methods for operating a geofencing application as part of the security access system 200. A geofence can be a boundary or perimeter located a predetermined distance away from a physical location or base position and can be used to determine a geographical area of interest to identify when the user 102 enters or exits a geofenced an area with predetermined boundaries around the lock 106. The geofence can be a radius around a base station, such as the cellular tower 118 or the access point 116. In one example, a geofence can be a boundary box, e.g., any geometric shape or arbitrary shaped-boundary that can be geographically located on a map. The personal access device 104 can then be tracked using GPS coordinates, triangulation, etc. The technology of geofencing can include determining a latitude and longitude location of an electronic device (for a GPS relative to the base position). In some geofencing applications, an object that is being tracked can either be inside the boundary, outside the boundary, or on a boundary line.

For a geofencing application 222 utilizing a cellular tower 118 or Wi-Fi access point 116, the application can determine when the personal access device 104 has entered the boundary set relative to a detection of transmitting either a cellular or Wi-Fi signal to the base station. For example, the personal access device 104 can be tracked using the cellular signal from a cell tower 118 to determine that the device is within a geofencing boundary (e.g., range of signal) around the cellular tower 118. When the personal access device 104 connects to a Wi-Fi signal transmitted from the access point 116 (used as a second geofencing boundary), the application 222 can determine that the mobile device is within the secondary boundary defined by the range of a Wi-Fi broadcast signal. At some point in the tracking of the personal access device 104 in the Wi-Fi determined boundary, the application may turn on the GPS receiver 236 to determine where the personal access device 104 is located relative to the geofence and relative to the location of the lock 106. It can be advantageous to use such a tiered approach to a geofencing application for power management purposes. Cellular communication and Wi-Fi communication are relatively low-power applications as compared to higher power consumption by the GPS receiver 236.

Thus, to determine a location of the user 102, the embodiments can configure and implement a geofencing application using the personal access device 104 carried by the user 102. Geofencing can be used as an alternative to constantly tracking the user's 102 location using GPS receiver 236, which as stated above can constitute prohibitive power consumption of the personal access device 104. As an example, the geofencing module 264 or personal access device 104 application 222 can define a geographical area and ask to be notified whenever the user 102 enters or exits the area. The application 222 may only check the personal access device's location periodically, or when the device is in the vicinity of a registered geofencing area, which can reduce drain on a battery and economize on battery life. In an embodiment, if the geofencing area is large enough, the network server application 222 may use Wi-Fi based triangulation in wireless network 117 or triangulation in cellular network 119 to determine whether a border of the area has been reached by user 102, instead of using a GPS signal received by satellite positioning receiver 236.

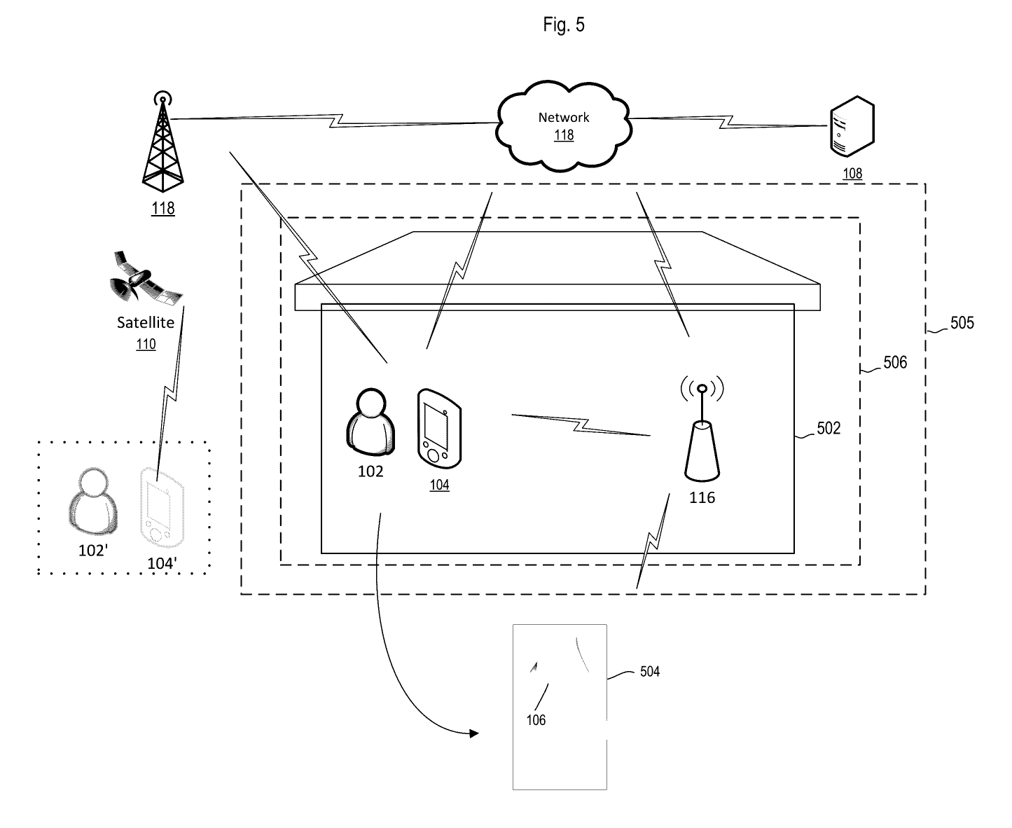

FIG. 5 is a schematic of an illustrative architecture for facilitating operations of the embodiments. A building 502 (e.g., house, office, warehouse, etc.) includes a door 504 that can be configured with the lock 106 to provide access to the building by the user 102. The user 102 and the personal access device 104 may be located on the inside of the building 502 or the user 102′ and the personal access device 104′ may be located on the outside of the building 502. The wireless network 117 can be located inside the building 502, outside building 502, or both inside and outside the building 502. A first geofencing barrier 505 can be setup around the building 502 using cellular network 119 that can determine if the user 102 has entered or exited the area and a second geofencing barrier 506 can be setup using wireless network 117 within the first barrier 505.

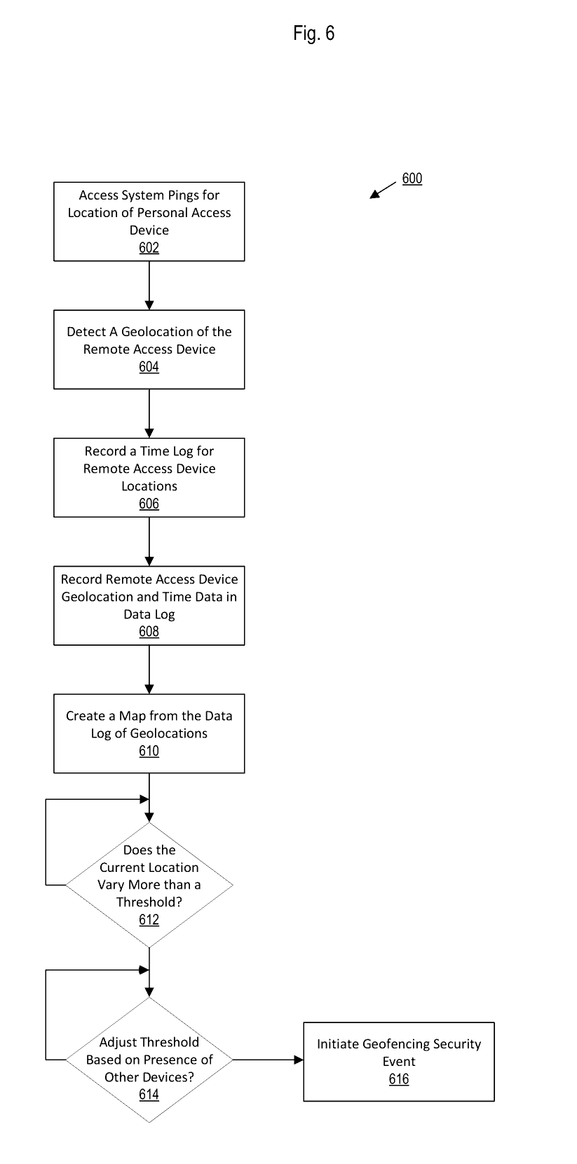

FIG. 6 is a flowchart of an exemplary process 600 for detecting a geolocation of the personal access device 104 based on a variance from a map of geolocations. The process 600 may be executed in logic steps by the processor 224, network server 108, or the application server 258. The algorithm or process 600 may a known or future-developed the geofencing application. For clarity of the disclosure, the process will be explained in context of the application server 258 executing logic and commands from geofencing module 264. The process 600 and algorithm may include block 602, where the application server 258 pings for a location of the personal access device 104. In block 604, the process 600 may include detecting a location of the personal access device 106 using one or more of the geolocating techniques described above. In block 606, the application server 258 can record a time log for the personal access device 104 locations to database 268. Block 608 can include the application server 258 recording the personal access device's geolocations and time date in the database 268. In block 610, a map can be created from the movements of the personal access device 106 based on a plurality of temporal geolocation data. The map may be a multidimensional map including a latitude dimension, a longitude dimension, an elevation dimension, a time dimension, and a date dimension. In order to determine whether the user 102 is within the parameters of a mapped geofencing area, at decision block 1310 the application server 258 can compare the current geolocation of the personal access device 104 with the mapped parameters and determine whether the current geolocation parameters indicate that the personal access device 104 is within a geofencing boundary. If the amount of variance is less than a threshold, then the process 600 returns to initiate block 612 to determine if the current location varies more than a threshold. If the result of decision block 612 is positive, then the process 600 can include block 614 to adjust the threshold based on the presence of other personal access devices. If multiple users are detected, then in block 614 the process can repeat until some or all users are accounted for in the calculation of thresholds. In block 616, the application server 258 can initiate a geofencing security event to either lock or unlock the lock 106.

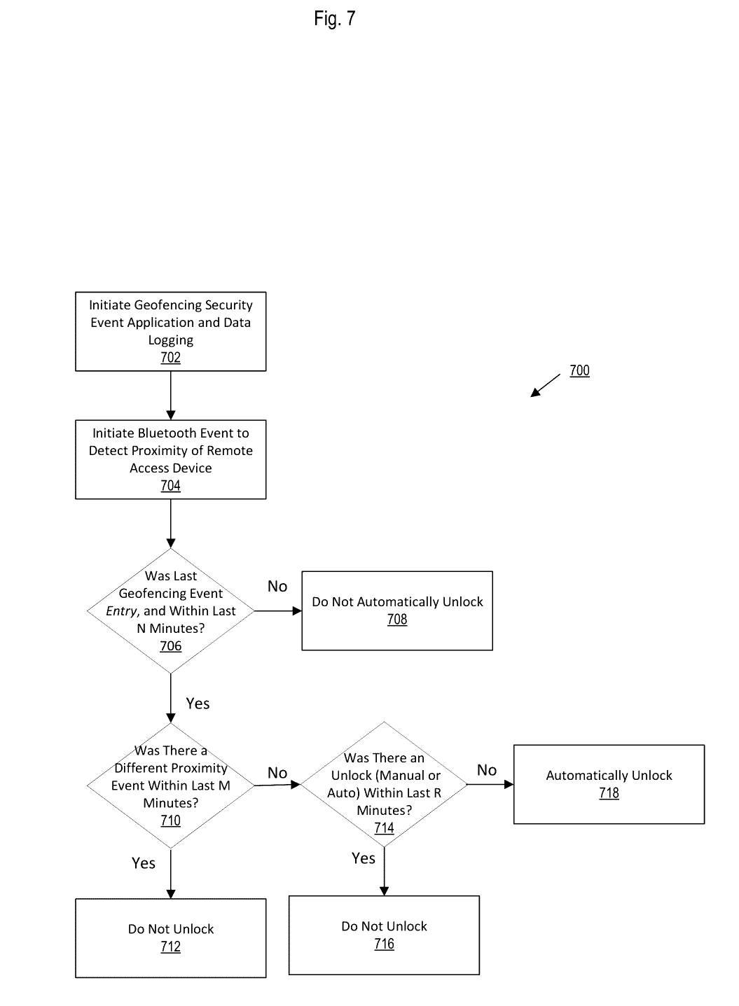

In an embodiment, the application server 258 can manage all of the geofencing state and operations, including tracking entering and exit events for multiple users 102 in order to make a determination to transmit a lock or unlock command to lock 106 during a security event (described below in relation to FIG. 7). In other embodiments, the processor 224 and application 222 from the portable access device 104 can interoperate with the application server 258 to share execution of the geofencing operations. In some embodiments, the portable access device 104 can execute all of the geofencing operations.

FIG. 7 is a flowchart of an exemplary process for a geofencing locking event to activate the lock 106 according to some embodiments. It should be understood that the process 700 can be performed using a processor, memory, instructions, and circuitry in one or any of the personal access device 104, the network server 108, the application server 258, or the lock 106. Further, the process 700 may be executed in logic steps by the processor 224, the processor 204, network server 108, or the application server 258 either in shared operations or exclusive operations. To configure a geofencing application to operate automatic unlocking of the lock 106, logic can be implemented that if the user 102 has only recently entered an area surrounding the building 502, then the user 102 has just arrived to the building 502 and desires the door 504 unlocked when the user 102 approaches the door 504. In one example, the user 102 may approach the door 504 several minutes (e.g., a customizable time such as up to 10 minutes, 15 minutes, etc.) after first entering the first geofenced area 505. In another example, a user 102 living in a large apartment building may enter the geofenced area 505 but a time period to actually approach the user's apartment may extend several minutes. Alternatively, if the user 102 enters the geofenced area 505 a considerable time before approaching the lock 104, or the user 102 has previously approached the lock 106 during that period of time, then the user 102 is probably inside of the apartment and does not desire an automatic unlock.

To address geographic distances, the lock 106 can include the short-range communication circuitry (e.g., Bluetooth® subsystem) 214 that can pair with a short-range transceiver 235 (e.g., Bluetooth® subsystem) on the personal access device 104. The notifications of user 102 entry and exit events can be generated by the personal access device's short-range communication when the personal access device 104 is within range of the short-range communication of the lock 106, which is can be in a range of tens of meters.

The process 700 can include block 702, to initiate the geofencing security event application and data logging. In block 704, the process can initiate a Bluetooth® or equivalent event to detect proximity of the personal access device 104. In the decision block 706, the process can include determining if the prior geofencing event was an Entry event, and did the event occur within the last N minutes. If the determination is negative, then the process 700 does not automatically unlock the lock 104 at block 708. If the determination is positive, then in decision block 710 the process can include a determination if there was a different proximity event within the last M minutes. If the determination is positive, then the process in block 712 does not unlock the lock 106. If the determination is negative, then the process proceeds to decision block 714 to determine whether there was an unlock (either manual or automatic) within the last R minutes. If the determination is negative, then the process can automatically unlock the lock 106 in block 718. If the determination is positive, then the process does not unlock the lock 106 in block 716.

Threats to a person are not symmetric, and the potential dangers of an incorrect assessment are likewise not symmetric. For example, if the user 102 is inside the building 502, and the building 502 is the user's home, and a stalker is outside of the door 504 attempting to gain forcible/illegal entry, the consequences of an unintended unlock are more serious than if the user 102 is not in the building 502 and, for example, a burglar gains forcible/illegal entry. If the user 102 is in the building 502, the consequences of an intended unlock that does not occur are less serious because the user 102 can execute a manual unlock on the lock 106. For threat model based assessment, an application of the embodiments can apply logic of whether the user 102 is in the building 502 (e.g., based on multi-user geofencing), and particularly whether the user 102 is just inside the door 504. In such a scenario, the logic can lower a likelihood that an automatic unlock occurs.

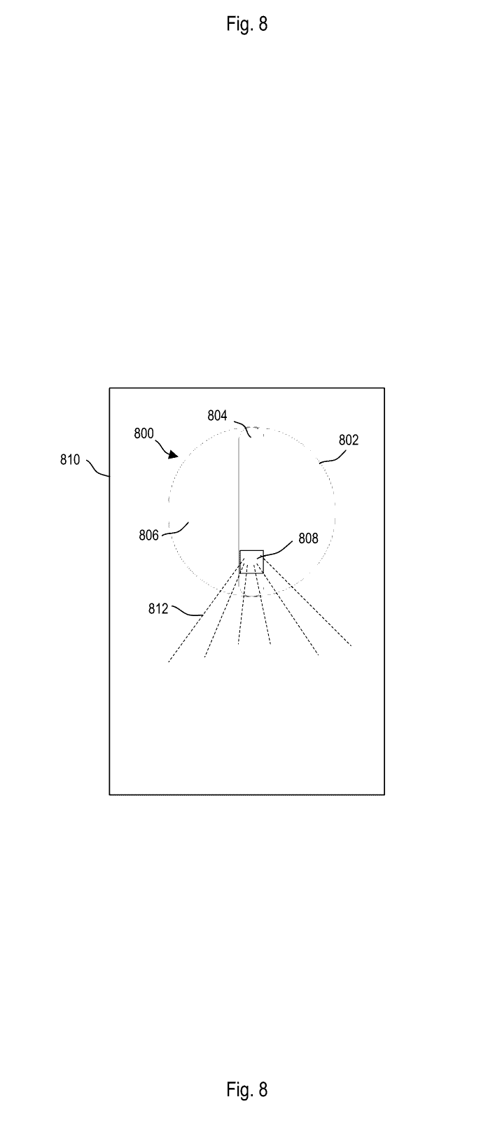

FIG. 8 is plan view of an alternative embodiment of the lock 106 of FIG. 2 configured with a motion detection device. The lock 800 can include a handle 806 formed as an elongated frusto-conical surface that begins at a circular base 802 and terminates at truncated handle top 804. The lock 800 may be mounted to a door 810 or other structure. In other embodiments, the lock 800 may be configured in other shapes such as, but not limited to, polygonal, cylindrical, conical, etc. and may include one or more apparatuses combined into an assembly to form the lock 800 or may include one or more apparatuses separated by physical distances the operate to function as automatic lock 800. In other embodiments, the lock 800 can be configured as a doorknob lock, handle lock, or other style lock. The lock 800 can be operationally or physically connected to a motion detector with a motion sensor 808. A motion sensor 808 of the embodiments can include or otherwise cover apparatus and sensors for short range radar, active infrared ranging, ultrasonic ranging, laser ranging (e.g., LIDAR), passive infrared (PIR) detector, optic-based cameras, etc.

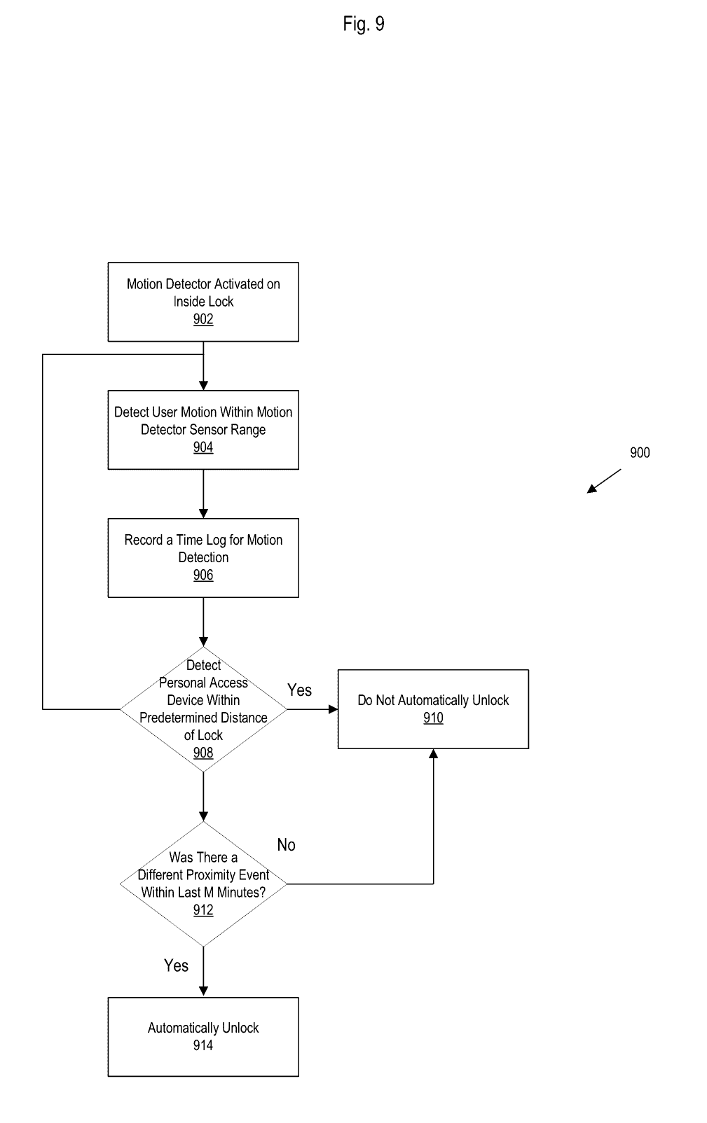

FIG. 9 is a flowchart of an exemplary process 900 for operation of the alternative lock of FIG. 8. The process 900 can be executed by the processor 204. There can be a risk if the user 102 moved to the door 810 to answer a doorbell or knock, and the person outside the door 810 is someone intending forcible/illegal entry. In an embodiment, if the user 102 is determined to be moving inside near door 810, when the personal access device 104 comes in proximity to the lock 800, logic for the lock 800 will not automatically actuate an unlock. If the user desires to override the logic, then the user 102 can manually unlock the lock 106. It would be beneficial to address at least one of the issues described above in context of the lock 106.

The process 900 can include block 902 where the processor 204 can activate the motion detector 808 on the lock 800 inside the door 810. In block 904, the processor 204 can detect user 102 motion within the motion sensor 808 sensor range. In the next block 906, the processor 204 can record a time log for the motion detection events. Data from the motion sensor 808 can be saved to memory 206. In the decision block 908, the processor can determine whether the lock 800 can detect the user's personal access device 104 within a predetermined distance of the lock 800. If the personal access device 104 can be detected, then in block 910 the logic operation does not prompt the processor 204 to automatically unlock the lock 800. If the personal access device 104 cannot be detected, then the processor 204 proceeds to decision block 912 to determine whether there was a different proximity event within the last M minutes. If there was an event in the time frame, then in block 914 the processor 204 can transmit an automatic unlock command that can be executed by the lock 800 controller 208. If there was no event in the time frame, then the processor 204 can transmit a do not automatically unlock command that can be executed by the lock 800 controller 208.

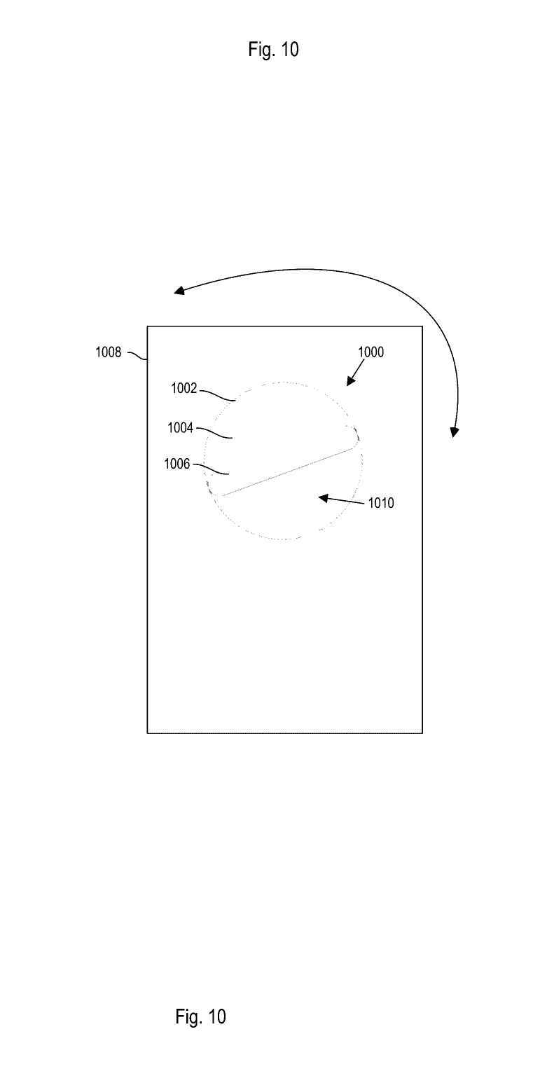

FIG. 10 is a plan view of the lock 106 configured with an accelerometer according to an alternative embodiment. The alternative embodiment lock 1000 can include a handle 1004 formed as an elongated frusto-conical surface that begins at a circular base 1002 and terminates at truncated handle top 1006. The lock 1000 may be mounted to an inside of a door 1008 or other structure. In other embodiments, the lock 1000 may be configured in other shapes such as, but not limited to, polygonal, cylindrical, conical, etc. and may include one or more apparatuses combined into an assembly to form the lock 1000 or may include one or more apparatuses separated by physical distances the operate to function as lock 1000. In other embodiments, the lock 1000 can be configured as a doorknob lock, handle lock, or other style lock. The lock 1000 can include accelerometer technology including, but not limited to an accelerometer 1010.

Related art electronic locks for the consumer market are commonly retrofit devices that replace some, but not all, aspects of an existing lock. Other related art electronic locks do not remove the existing lock's turn knob and instead actuate the turn knob itself. These related art locks often need to be smaller in size, and it can be difficult to incorporate all the sensors, such as encoders, that one would have in a full replacement electronic lock, without sacrificing flexibility or size.

It can be beneficial, therefore, to address one or more of the problems described above. The lock 1000 can include one or more sensors 1010 that can indicate whether the deadbolt is currently in a locked or unlocked position. The lock 1000 can also include one or more sensors 1010 that can indicate whether the door 1008 to which the lock 1000 is attached is in an open or closed position. For example, the lock 1000 can include one or more of: the accelerometer 212 such as a MEMS accelerometer, the gyroscope 213 such as a MEMS gyroscope, or the compass 211 as one or more of the sensors 1010 to determine a locked/unlocked and/or door position status. For example, a MEMS accelerometer can determine when the lock 1000 is at rest. When the lock 1000 is at rest, the force is approximately 1 g (from gravity) and is unchanging in every direction (the accelerometer can detect the direction of gravity and thus the angle/tilt of the lock 1000 with respect to the Earth). This detection can determine whether the lock 1000 is currently locked (or unlocked). The MEMS gyroscope 213 in lock 1000 can be used to measure the lock's angular velocity and integrate that velocity to measure how the lock 1000 has turned since the lock 1000 was last at rest.

When the application 222 determines that an unlock (lock) operation is warranted, either because of an automatic request or a user's manual operation, the logic of the application 222 can determine if the lock is already in an unlocked (locked) position and take no action, or was previously locked (unlocked) and initiate the unlocking (locking) process. After a logic decision to lock or unlock is initiated, the controller 208 must determine how far to turn the handle 1004 to execute the lock/unlock command.

A related art method may use a simple timer to determine how far to turn a lock for a lock/unlock event. However, executing a lock/unlock command based on a timer has certain disadvantages. For example, in configuring lock 1000 a user 102 could assume that a lock action requires 3 seconds and an unlock action requires 5 seconds, or the user 102 could attempt to calibrate a time period for each action, or a user may select action times from a library of lock action times. However, these approaches are not reliable methods of electronic lock calibration because of mechanical tolerances and flexibility in the lock 1000. A more advantageous method is to measure the exact distance the lock 1000 rotates for each lock/unlock action.

A related art accelerometer may not fully accurately measure the exact distance the lock 1000 rotates for each lock/unlock action. This can be because operation of the accelerometer for angle measurement assumes that the lock 1000 is at rest, when the only force acting on the accelerometer is a force of gravity. However, it can be advantageous that the lock 1000 can incorporate a gyroscope 213 to measure the lock's angular velocity and integrate that velocity to measure the rotational movement of the lock 1000 when the lock was at rest. Even in the absence of the gyroscope 213, it may be advantageous to use data from the accelerometer 212 to measure gravitational angles by filtering out the effect from the motion of the lock 1000.

It can also be advantageous to determine whether the door 1008 is in an open or closed position or at a position between an open or closed position. While the door 1008 is in an open position, it can be a disadvantage to lock a deadbolt lock because the door 1008 cannot close again if the bolt is extended. During a setup process, the application 222 can query the user 102 to close the door 1008 and provide an input, such as tapping an input button on the GUI, and then open the door 1008 and provide a second input confirming the door 1008 status. In both stages of the calibration process, the processor 204 via the application 222 can measure the direction of the Earth's magnetic field using a magnetometer 215, such as a MEMS magnetometer, and the processor 204 can determine the typical compass bearing using compass 211 when the door 1008 is in an open position and when the door 1008 is in a closed position. The measured compass bearings can be used by the controller 208 during lock 1000 operation to measure whether the door 1008 is in an open or closed position, and thus determine whether an automatic locking action or automatic unlocking action is appropriate.

Closing the door 1008 can cause specific vibrations associated with a door closing action. In one embodiment, door vibrations can be measured by the accelerometer 212. During the setup process for the lock 1000, vibrations detected by the accelerometer 212 can be calibrated to a door closing action, and then associated with an indication of a closed position of the door. The exemplary embodiments can use the sensor-based detection methods for calibration and detection of lock and door positions. The sensors (e.g., accelerometer 212, gyroscope 213, compass 211, magnetometer 215, etc.) can be mounted to any appropriate location or component in the lock 106, such as a printed computer board (not shown). In related solutions, some sensors are connected via a PCB to a lock's turn follower. Thus, the position and state of the turn follower correlates directly the state of a lock. In some related solutions, a manual turn of the lock can cause action against a motor (often through various gearing), which can damage the lock mechanism. The disclosed embodiments are therefore advantageous to provide a predetermined amount of slack or indirection in the lock 106. Further, a PCB 205 of lock 106 does not directly connect to the turn follower. Thus, the PCB 205, under certain circumstances, can rotate on its own the predetermined distance even when the lock itself is not rotating. The embodiments can include a mechanical switch as a component of the lock mechanisms 202 that can detect an actual mechanical engagement with the lock 106. For a lock/unlock action, it may be beneficial to first actuate a motor (which can be a component of the lock mechanisms 202), without information regarding the state of the lock 106, until the mechanical switch is closed. At such a state, the controller 208 can determine that the lock 106 is mechanically engaged, and the processes for a lock/unlock action may proceed. In one embodiment, the measured PCB angle can only correlate with a lock state once the lock 106 is in a known engaged state.

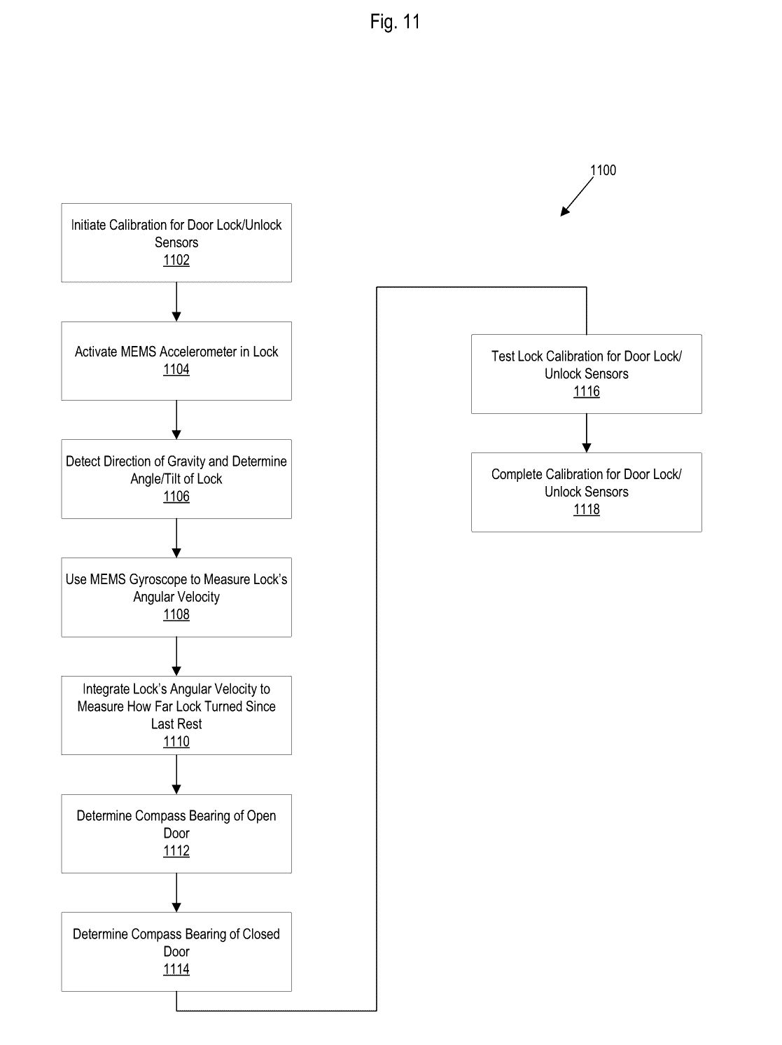

FIG. 11 is a flowchart of an exemplary process 1100 for calibrating the embodiments of locks 106, 800, 1000 of the embodiments. For clarity of the disclosure, the process 1100 will be described in context of the lock 1000 of FIG. 10. Further, the process 1100 may be executed in logic steps by the processor 224, the processor 204, network server 108, or the application server 258 either in shared operations or exclusive operations. For clarity of the disclosure, the process 1100 may be executed in context of the processor 204. The process 1100 can include block 1102 where the processor 204 can initiate a calibration for the lock 1000 sensors for lock and unlock positions and events. The processor 204 can activate the accelerometer 212 in the lock 1000. Once activated in block 1104, the accelerometer 212 can detect a direction of gravity and determine the angle/tilt of the lock 1000 in block 1106. The processor 204 can use the gyroscope 213 to measure the lock's angular velocity in block 1108. The calibration process 1100 can further include block 1110 where the processor 204 can integrate the lock's 1000 angular velocity to measure how far the lock 1000 turned since the last rest position. In block 1112, the processor 204 can determine a compass bearing of an open door 1008, and in block 1114 the processor 204 can determine a compass bearing of a closed door 1008 using the compass 211. To complete calibration, in block 1116 the processor 204 can test the lock 1000 calibration for the door 1008 lock and unlock sensors 1010. In block 1118, the calibration process 1100 for the door lock/unlock sensors 1010 is complete.

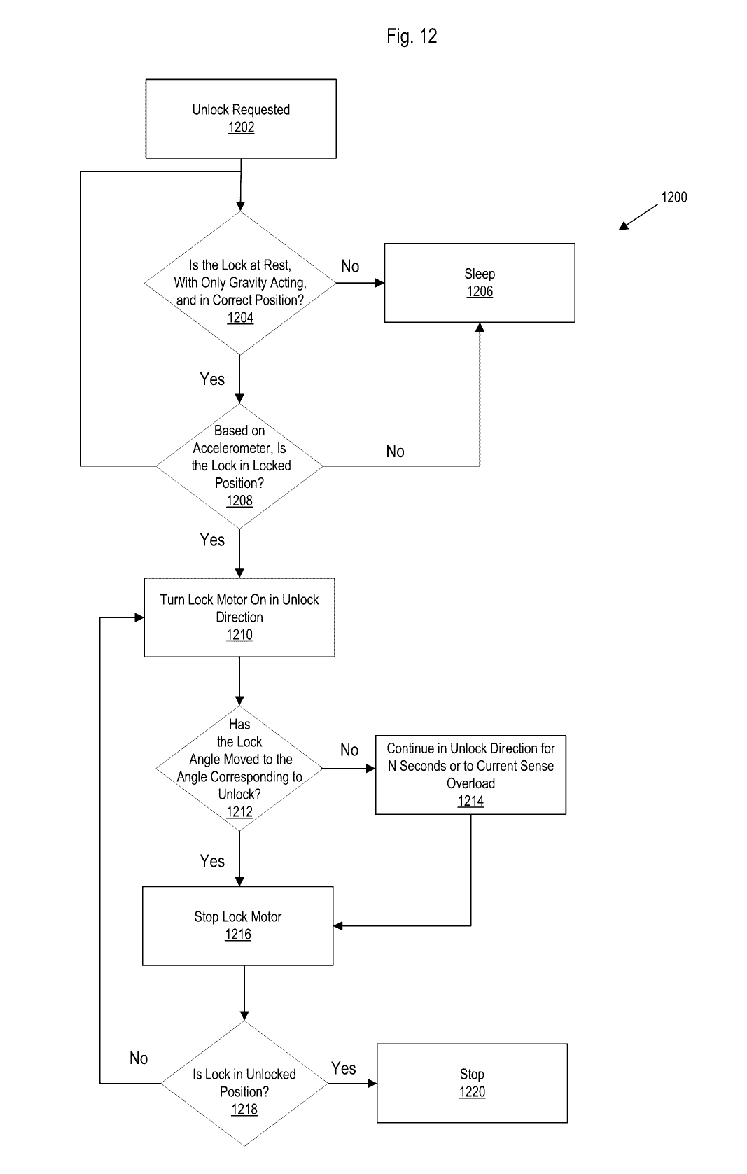

FIG. 12 is a flowchart of an exemplary process 1200 for operating the lock of the embodiments after the calibration process 1100. For clarity of the disclosure, the process 1200 will be described in context of the lock 1000 of FIG. 10. Further, the process 1200 may be executed in logic steps by the processor 224, the processor 204, network server 108, or the application server 258 either in shared operations or exclusive operations. For clarity of the disclosure, the process 1200 may be executed in context of the processor 204. The process 1200 for operating the lock 1000 can include block 1202 where an unlock action is requested by the processor 204, after which in decision block 1204 the processor 204 determines whether the lock 1000 is at rest, with only gravity acting on the lock 1000, and whether the lock 1000 is in the correct position. If either condition is not met, then the processor 204 can place the lock 1000 in a sleep mode in block 1206. If both conditions are met, then in decision block 1208 the processor 204 can determine, based on the accelerometer 212, that the lock 1000 is in a locked position. If the lock 1000 is not in the locked position, the in block 1206 the lock 1000 is placed in a sleep mode. If the lock 1000 is in the locked position, then in block 1210 the processor 204 can instruct the controller 208 to turn the lock motor 202 in an unlock direction. The processor 204 can proceed to decision block 1212 where the processor 204 can determine whether the lock angle has moved to the angle corresponding to unlock. If the lock 1000 has not moved to the proper position, then the processor 204 can proceed to block 1214 where the processor 204 can instruct the controller 208 to continue lock movement in the unlock direction for N seconds or to a dedicated limit using one of the sensors 210 to determine an overload in electrical current. Once complete, the process can return to block 1216 to stop the lock motor 202. However, if the processor 204 determines that the lock angle moved to the angle corresponding to unlock in block 1212, then the processor 204 can proceed to block 1216 where the controller 208 can stop the lock motor 202. The processor 204 can proceed to decision block 1218, where the processor 204 can determine whether the lock 1000 is in an unlocked position. If not determined, then the process reverts back to block 1210 to turn the lock motor 202 on in an unlock direction. If determined, then the process stops in block 1220.

The above described techniques may take the form of computer or controller implemented processes and apparatuses for practicing those methods. The various example methods and/or steps described herein may be performed, at least partially, by one or more processors that can be temporarily configured to perform the relevant operations. Whether temporarily or permanently configured, such processors may constitute processor-implemented modules that can operate to perform one or more operations, steps, or functions. The modules referred to herein may, in some example embodiments, comprise processor-implemented modules.

The disclosure may also be embodied in the form of computer program code or non-transitory signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the embodiments. When implemented on a general-purpose microprocessor, the computer program code segments configure the microprocessor to create specific logic circuits. A computer program can be written in any form of programming language, including compiled or interpreted languages, and it can be deployed in any form, including as a stand-alone program or as a module, subroutine, or other unit suitable for use in a computing environment. These computer programs can be executed in many exemplary ways, such as an application that is resident in the memory of a device or as a hosted application that is being executed on a server or on multiple computers at one site or distributed across multiple sites and communicating with the device application or browser via any number of standard protocols, such as but not limited to TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Exemplary embodiments are intended to cover execution of method steps on any appropriate specialized or general purpose server, computer device, or processor in any order relative to one another. Some of the steps in the embodiments can be omitted, as desired, and executed in any order. In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

A computer architecture of the embodiments may be a general purpose computer and/or processor or a special purpose computer and/or processor. A computer and/or processor can be used to implement any components of a computer system or the computer-implemented methods of the embodiments. For example, components of a computer system can be implemented on a computer via its hardware, software program, firmware, or a combination thereof. Although individual computers or servers are shown in the embodiments, the computer functions relating to a computer system may be implemented in a distributed fashion on a number of similar platforms, to distribute the processing and/or functional load.

Embodiments are intended to include or otherwise cover methods of using and methods of manufacturing the lock 106 and security access system 200 disclosed above. The methods of manufacturing include or otherwise cover processors and computer programs implemented by processors used to design various elements of the security access system 200 above. For example, embodiments are intended to cover processors and computer programs used to design or test the security access system 200, lock 106, and the alternative embodiments of the lock 106.

Exemplary embodiments are intended to cover all software or computer programs capable of enabling processors to execute instructions and implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed above. The disclosure can also be embodied in the form of computer program code containing instructions embodied in non-transitory machine-readable tangible media or any other computer-readable storage medium, wherein, when the computer program code is loaded into and executed by a computer or controller, the computer becomes an apparatus for practicing the embodiments

Embodiments are amenable to a variety of modifications and/or enhancements. For example, although the implementation of various components described above may be embodied in a hardware device, it can also be implemented as a software-only solution, e.g., an installation on an existing server. In addition, systems and their components as disclosed herein can be implemented as a firmware, firmware/software combination, firmware/hardware combination, or a hardware/firmware/software combination.

Some of the disclosed embodiments include or otherwise involve data transfer over a network, such as communicating various inputs over the network. The network may include, for example, one or more of the Internet, Wide Area Networks, Local Area Networks, analog or digital wired and wireless telephone networks (e.g., a PSTN, Integrated Services Digital Network, a cellular network, and Digital Subscriber Line, radio, television, cable, satellite, and/or any other delivery or tunneling mechanism for carrying data. A network may include multiple networks or sub-networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode, and may support voice using or other comparable protocols used for voice data communications. In one implementation, the network includes a cellular telephone network configured to enable exchange of text or SMS messages. The software and instructions used in the embodiments may be embodied in a non-transitory computer readable medium. The term “non-transitory computer readable medium” should be understood to include a single medium or multiple media (e.g., a centralized or distributed database, and/or associated caches and servers) that store the one or more sets of instructions. The term “non-transitory computer readable medium” should also be understood to include any medium that is capable of storing or encoding a set of instructions for execution by any of the processors, servers, or computer systems and that cause the processors, servers, or computer systems to perform any one or more of the methodologies of the embodiments. The term “non-transitory computer readable medium” should further be understood to include, but not be limited to, solid-state memories, and optical media, and magnetic media.

Certain systems, devices, apparatus, applications, methods, processes, or controls are described herein as including a number of modules or component parts. A component part may be a unit of distinct functionality that may be presented in software, hardware, or combinations thereof. When the functionality of a component part is performed in any part through software, the component part includes a non-transitory computer-readable medium. The component parts may be regarded as being communicatively coupled. The embodiments according to the disclosed subject matter may be represented in a variety of different embodiments of which there are many possible permutations.

While the subject matter has been described in detail with reference to exemplary embodiments thereof, it will be apparent to one skilled in the art that various changes can be made, and equivalents employed, without departing from the scope of the invention.

What is claimed is:

1. An electronic lock for controlling a lock mechanism, comprising:
a processor;
a controller coupled to the processor and configured to change a locked/unlocked status of the electronic lock;
a first communication receiver coupled to the processor, the first communication receiver configured to receive information indicating a user proximity event relative to the electronic lock; and
a transceiver coupled to the processor, the transceiver configured to receive data from a remote application over a network,
the processor configured to:
define a geofencing boundary around the electronic lock,
transmit the geofencing boundary information to the remote application over the network;
receive data from the remote application over the network indicating a geofencing entry or exit event; and
transmit an unlock command to the controller if:
a) the first communication receiver receives information of the proximity event indicating the user's location within a predetermined distance of the electronic lock, and
b) the processor receives data indicating the geofencing entry event occurred within a first predetermined prior time frame.

2. The electronic lock of claim 1, wherein the processor is further configured to not transmit an unlock command if the processor receives data indicating the geofencing entry event occurred beyond the first predetermined prior time frame.

3. The electronic lock of claim 1, wherein the processor is further configured to determine if a different proximity event occurred within a second predetermined prior time frame.

4. The electronic lock of claim 3, wherein the processor is further configured not to transmit an unlock command if the different proximity event occurred within the second predetermined time frame.

5. The electronic lock of claim 3, wherein the processor is further configured to determine if an unlock event occurred within a third predetermined time frame.

6. The electronic lock of claim 5, wherein the processor is further configured to transmit an unlock command if:
a) the processor receives data indicating no unlock event occurred within the third predetermine time frame, and
b) the processor receives data indicating that no different proximity event occurred within the second predetermined prior time frame.

7. The electronic lock of claim 5, wherein the processor is further configured not to transmit an unlock command if the processor receives data indicating an unlock event occurred within the third predetermined time frame.

8. The electronic lock of claim 3, further comprising:
a second sensor configured to detect motion of the user when the user is within a predetermine range of the electronic lock.

9. The electric lock of claim 8, wherein the processor is further configured to transmit an unlock command to the controller if:
a) the second sensor detects the user within the predetermined range,
b) the first communication receiver receives information of the proximity event indicating the user's location within the predetermined distance of the electronic lock, and
c) the processor receives data indicating that no different proximity event occurred within the second predetermined prior time frame.

10. A computer-implemented method for controlling an electronic lock, comprising:
under one or more computer systems configured with executable instructions, defining a geofencing boundary around the electronic lock;
receiving data from an application indicating a user geofencing entry event;
receiving configuration data including a locked/unlocked status of an electronic lock;
receiving information from the electronic lock indicating a user proximity event relative to the electronic lock;
transmitting, by the one or more computer systems, an unlock command to electronic lock if:
a) the information indicating the proximity event indicates the user's location within a predetermined distance of the electronic lock, and
b) the geofencing entry event occurred within a first predetermined prior time frame.

11. The computer-implemented method of claim 10, further comprising:
defining first predetermined prior time within which a geofencing entry event by the user that will cause the computer system to transmit the unlock command to the electronic lock.

12. The computer-implemented method of claim 10, wherein the information indicating a user proximity event includes data determining if a different proximity event occurred within a second predetermined prior time frame.

13. The computer-implemented method of claim 12, further comprising:
preventing the computer system from transmitting the unlock command if the different proximity event occurred within the second predetermined time frame.

14. The computer-implemented method of claim 12, further comprising:
preventing the computer system from transmitting the unlock command if an unlock event occurred within a third predetermined time frame.

15. The computer-implemented method of claim 14, further comprising:
transmitting the unlock command if:
a) no unlock event occurred within the third predetermine time frame, and
b) no different proximity event occurred within the second predetermined prior time frame.

16. The computer-implemented method of claim 14, further comprising:
preventing the computer system from transmitting the unlock command if an unlock event occurred within the third predetermined time frame.

17. The computer-implemented method of claim 12, further comprising:
sensing motion of the user when the user is within a predetermine range of the electronic lock.

18. The computer-implemented method of claim 17, further comprising:
transmit the unlock command to the electronic lock if:
a) the sensing detects the user within the predetermined range,
b) the proximity event indicates the user's location within the predetermined distance of the electronic lock, and
c) no different proximity event occurred within the second predetermined prior time frame.

19. One or more non-transitory computer-readable mediums storing computer readable instructions that, when executed by one or more processors, instruct a computing device to perform acts comprising:
defining a geofencing boundary around the electronic lock,
receiving data from an application indicating a user geofencing entry event;
receiving configuration data including a locked/unlocked status of an electronic lock;
receiving information from the electronic lock indicating a user proximity event
